(19) United States
(12) Patent Application Publication
(10) Pub. No.: US 2005/0172064 A1
(43) Pub. Date: Aug. 4, 2005

(54) Method and apparatus for addressing in mass storage non-volatile memory devices

(76) Inventor: Marcelo Krygier, Kyriat Ono (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/766,320

(22) Filed: Jan. 29, 2004

(51) Int. Cl. G06F 12/00

(52) U.S. Cl. 711/4; 711/2

(57) ABSTRACT

An apparatus and method to determine an addressing mode is disclosed. The method uses one or more unused bits of an address argument of a command as an addressing mode field to determine whether the address argument is a byte address argument or a block address argument.

### BACKGROUND OF THE INVENTION

Memory devices for non-volatile storage of information are currently in widespread use today in numerous applications. For example, flash memory devices, such as, for example MultiMediaCard (MMC) and Secure Digital (SD) card may be used with cellular telephones, personal digital assistants, digital cameras and music players.

Access operations to data within a flash memory device, such as SD and MMC are performed via read/write commands. A portion of the command is a specific address representing the location of a specific data within the memory device. Currently, addresses are expressed as byte addressed 32-bit arguments. The use of a 32-bit argument may produce 2³¹ different byte addresses, which may individualize up to 4 GBytes of data. There is a need for another solution for addressing in mass storage memory devices having a larger capacity.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a block-diagram illustration of a host command according to some embodiments of the present invention;

FIG. 2 is a block-diagram illustration of a host device helpful in understanding the dual-mode addressing arrangement according to some embodiments of the present invention;

FIG. 3 is a block-diagram illustration of a host device helpful in understanding the dual-mode addressing arrangement according to some embodiments of the present invention; and

FIG. 4 is flowchart diagram illustration of a portion of a read operation or a write operation according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

Existing mass storage memory devices currently may have the capacity of storing up to 1 GB, and therefore byte addressing is suitable and is used in existing mass storage memory devices. The use of byte addressing is not suitable for new mass storage memory devices having a larger capacity.

A mode of addressing suitable for large capacity mass storage memory devices having more than 2 GB storage space may be block addressing. The address argument, in this case, represents an address of the first byte of a specific block. A block may comprise a predefined number of bytes, such as, for example, 512 bytes, 2048 bytes or 8192 bytes. A simple block addressing system, however, would be backwards incompatible with byte addressing standards.

In accordance with embodiments of the present invention, there is presented a hybrid memory addressing system. The use of the existing byte addressing mode to perform read and write operations by an existing host on a new memory device (having a capacity larger than 2 GB) may enable access only to the first 2 GB of the memory space on the new memory device. The use of block addressing mode to perform read and write operations on a new memory device (having a capacity larger than 2 GB) may not be backwards compatible and may not enable to perform read and write operations on a byte-addressing memory device.

In the following detailed description, numerous specific details are set forth in order to provide a thorough understanding of the invention. However, it will be understood by those of ordinary skill in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatus for performing the operation herein. This apparatus may be specially constructed for the desired purposes, or it may comprise a general-purpose computer selectively activated or reconfigured by a computer program stored in the computer. Such a computer program may be stored in a computer readable storage medium, such as, but not limited to, any type of disk, including floppy disks, optical disks, magnetic-optical disks, read-only memories (ROM's), compact disc read-only memories (CD-ROM's), random access memories (RAM's), electrically programmable read-only memories (EPROM's), electrically erasable and programmable read only memories (EEPROM's), FLASH memory, magnetic or optical cards, or any other type of media suitable for storing electronic instructions and capable of being coupled to a computer system.

The processes and displays presented herein are not inherently related to any particular apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of embodiments of the invention as described herein.

It should be appreciated that according to some embodiments of the present invention, the method described below, may be implemented in machine-executable instructions. These instructions may be used to cause a general-purpose or special-purpose processor that is programmed with the instructions to perform the operations described. Alternatively, the operations may be performed by specific hardware that may contain hardwired logic for performing the operations, or by any combination of programmed computer components and custom hardware components.

The method may be provided as a computer program product that may include a machine-readable medium having stored thereon instructions that may be used to program a computer (or other electronic devices) to perform the method. For the purposes of this specification, the terms “machine-readable medium” may include any medium that is capable of storing or encoding a sequence of instructions for execution by the machine and that cause the machine to perform any one of the methodologies of the present invention. The term “machine-readable medium may accordingly include, but not limited to, solid-state memories, optical and magnetic disks, and a carrier wave that encodes a data signal.

In some embodiments of the present invention, a mass storage media device is used. In the exemplary embodiments below, the architecture of a MultiMediaCard (MMC) or Secure Digital (SD) card is used. However, it should be understood to a person skilled in the art that the invention is not limited to MMC and SD cards only and may be equally applicable to other memory devices, such as for example, compact flash cards, memory stick, XD cards, disk on key and IBM Microdrive.

Although the scope of the present invention is not limited in this respect, the system and method disclosed herein may be implemented in many wired or wireless, handheld, and portable communication and entertainment devices. By way of example, communication and entertainment devices may include wireless and cellular telephones, smart telephones, personal digital assistants (PDAs), digital cameras, digital music players, and video games consoles. Alternatively, according to other embodiments of the present invention, the system and method disclosed herein may be implemented in computers.

Some embodiments of the present invention are directed to a method and apparatus to access data stored on mass storage memory devices having byte or block addressing with a single command structure capable of having instructions for both a byte addressing mode and a block addressing mode. The usage of an existing un-used physical bit of a byte addressing command may enable backwards compatibility to existing mass storage data memory devices and enable to interpret the address argument according to the appropriate addressing mode.

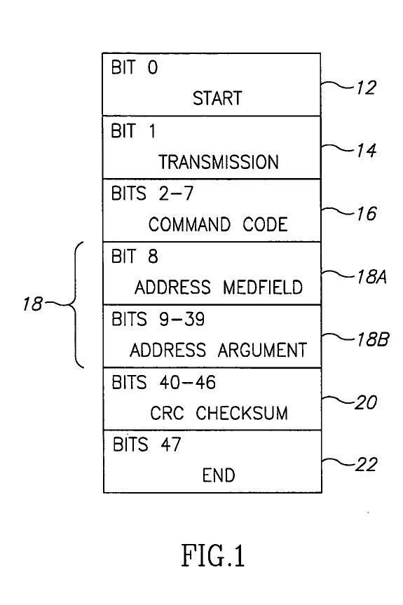

Reference is now made to FIG. 1, which is a simplified block-diagram illustration of a host command according to some embodiments of the present invention. In the exemplary illustration described below, a host command 10 may comprise 48 bits. One of ordinary skill in the art will understand that the selection of the command size and the functional division within the command is for illustration purposes only and embodiments of the present invention are not restricted to such a configuration.

Block 12 represents bit 0, which may be the “Start bit”, block 14 represents bit 1, which may be the “Transmission bit” and block 16 represents bits 2 to 7 which may comprise the command code. Block 20 represents bits 40 to 46 and may contain an error detection code and block 22 represents bit 47, which may be the “End bit”.

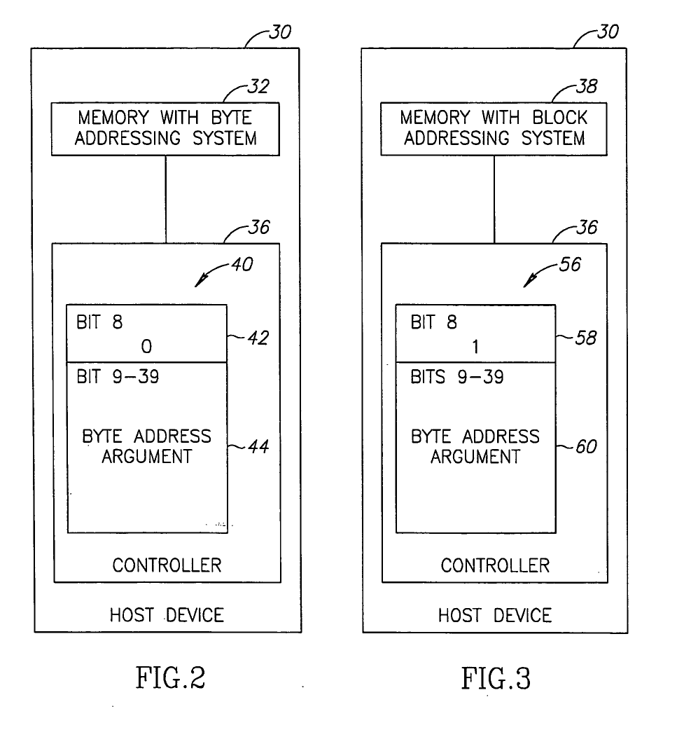

In the exemplary 48-bit host command 10, block 18 represents bits 8 to 39, which may comprise a 32-bit address argument. Block 18 may be divided into two portions. The first portion, block 18A, which in this exemplary embodiment represents bit 8, may function as an addressing mode field as explained in detail hereinbelow in FIGS. 2 and 3. The second portion, block 18B, which in this exemplary embodiment represents bits 9 to 39, may represent a 31-bit address argument.

It will be understood by a person skilled in the art that a 32-bit address argument is merely one exemplary embodiment, for example, compatible with the MMC and SD protocols, and embodiments of the present invention are not limited in this respect. According to other embodiments of the present invention, an address argument may comprise more or less than 32 bits, at least one of the bits may be an unused bit.

Writing data onto a mass storage device and reading the data from the mass storage memory device may be executed by sending write and read commands from the host device to a specific location on the memory device. The address argument represents an address within the address space of the mass storage memory device. Currently, to access mass storage data memory devices, such as, for example, MMC and SD, the address argument represents an address of a specific byte, namely the mode of addressing is byte addressing.

Theoretically, a 32-bit address argument may individualize up to 4 gigabytes (GB) of data. However, according to the protocols related to existing mass storage memory devices, such as MMC and SD, the least significant bit (LSB) or the most significant bit (MSB), namely bit 0 or bit 31 of the address argument is always 0. Therefore, the remaining 31 bits may individualize up to 2 GB.

Reference is now made to FIG. 2 and FIG. 3, which are block-diagram illustrations of a host device helpful in understanding the dual-mode addressing arrangement according to some embodiments of the present invention.

As shown in FIG. 2, a host device 30 may comprise a memory unit 32 having a byte-addressing system suitable for byte-addressing and a controller 36 to send commands to memory unit 32. Controller 36 may store a command having an address portion 40. An addressing mode field 42 may store the value zero to indicate that the address argument 44 is a byte addressing argument. Therefore, the command associated with address argument 44 may access data stored within memory unit 32 using byte addressing mode.

As shown in FIG. 3, host device 30 may comprise a memory unit 38 having a block-addressing system suitable for block addressing. Controller 36 may store a command having an address portion 56. An addressing mode field 58 may store the value one to indicate that the address argument 60 is a block addressing argument. Therefore, the command associated with address argument 60 may access data stored within memory unit 32 using block-addressing mode.

According to some embodiments of the present invention, a single memory device may be compatible with both byte-addressing and block-addressing systems. It will be understood to a person skilled in the art that an application may switch between byte addressing and block addressing modes as applicable.

In order to communicate to the host which addressing system is intended by the argument, the unused LSB or MSB, for example the 9th bit (bit 8) of host command 10 may be used as an addressing mode field. Thus, for example, if the 9th bit of command 10 equals zero (as illustrated in FIG. 2), then the remaining 31 bits, (bits 9 to 39) may represent a byte address. If the 9th bit of command 10 equals one (as illustrated in FIG. 3), then the remaining 31 bits, (bits 9 to 39) may represent a block address. It will be understood that in accordance with embodiments of the present invention, FIGS. 2 and 3 may refer to the same memory device compatible with both addressing systems.

It should be understood by a person skill in the art that the addressing mode field may be used for other purposes in the system such as, for example, management of program execution, data process and card wear leveling management.

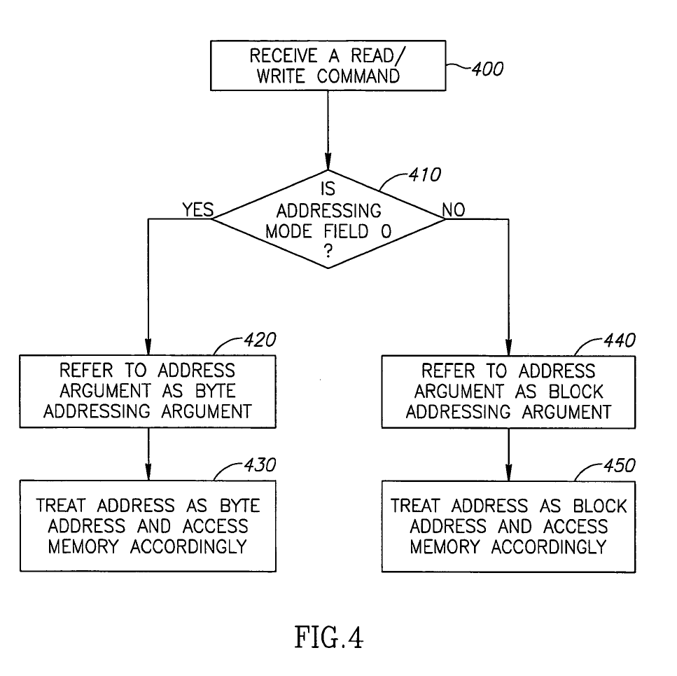

Reference is additionally made to FIG. 4, which is flowchart diagram illustration of a portion of a read operation or a write operation according to some embodiments of the present invention.

At operation 400, controller 36 of device 30 may be notified of a read or write command. Controller 36 then may determine whether the Addressing Mode field (which may be the least significant bit (LSB) or the most significant bit (MSB) of the address argument within the received command) has the value of zero. (operation 410). If the value of the Addressing Mode field is zero, controller 36 may refer to the address argument as a byte-addressing argument 44 (operation 420). The controller 36 then may enable access to a specific byte address within the byte addressing space 34 based on the data within the address argument (operation 430). If the value of the Addressing Mode field is one, controller 36 may refer to the address argument 18B as a block-addressing argument 60 (operation 440). The controller 36 then may enable access to the first byte of a specific block address within the block addressing space 44 based on the data within the address argument (operation 450).

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A method comprising:
using one or more unused bits of an address argument of a command as an addressing mode field to determine whether said address argument is a byte address argument or a block address argument.

2. The method of claim 1 comprising:
determining that the address argument is the byte address argument when the addressing mode field is zero.

3. The method of claim 1 comprising:
determining that the address argument is the block address argument when the addressing mode field is one.

4. The method of claim 2 further comprising:
accessing a byte address within a memory unit according to the byte address argument if said address argument is a byte address argument.

5. The method of claim 3 further comprising:
accessing a block address within a memory unit according to the block address argument if said address argument is a block address argument.

6. The method of claim 1, wherein using said one or more unused bits comprises using a least significant bit of said address argument.

7. The method of claim 1, wherein using said one or more unused bits comprises using a most significant bit of said address argument.

8. An apparatus comprising:
a memory unit; and
a controller to determine whether an addressing mode to access said memory unit is a byte addressing mode or a block addressing mode and to send a command to access data within said memory unit according to said addressing mode.

9. The apparatus of claim 8, wherein said memory unit is a multi media card (MMC).

10. The apparatus of claim 8, wherein said memory unit is a secure digital (SD) memory card.

11. The apparatus of claim 8, wherein the addressing mode is associated with the ninth bit of a 48-bit command having a 32-bit address argument.

12. The apparatus of claim 8, wherein the addressing mode is associated with the 31-st bit of a 48-bit command having a 32-bit address argument.

13. An article comprising a storage medium having stored thereon instructions that, when executed by a computing platform, result in:
using an addressing mode field of an address argument of a command to determine whether said address argument is a byte address argument or a block address argument.

14. The article of claim 13 wherein the instructions, when executed result in:
using one or more unused bits of the address argument as the addressing mode field.

15. The article of claim 13, wherein the instructions when executed further result in:
determining that the address argument is the byte address argument when the addressing mode field is zero.

16. The article of claim 13, wherein the instructions when executed further result in:
determining that the address argument is the block address argument when the addressing mode field is one.
